(19) United States
(12) Patent Application Publication
(10) Pub. No.: US 2005/0063305 A1
(43) Pub. Date: Mar. 24, 2005

(54) Method of updating flow control while reverse link is idle

(76) Inventors: Jeffrey L. Wise, Acton, MA (US); Stephen A. Hauser, Acton, MA (US)

Correspondence Address: MOTOROLA, INC., Corporate Law Department - #56-238, 3102 North 56th Street, Phoenix, AZ, 85018, US

(21) Appl. No.: 10/671,203

(22) Filed: Sep. 24, 2003

(51) Int. Cl. H04L 12/26

(52) U.S. Cl. 370/235; 370/253

(57) ABSTRACT

A method includes a link receiver (304) providing a plurality of data credits (320) to a link transmitter (302) and the link transmitter transmitting a packet (325) to the link receiver, where the link transmitter takes the packet from one of a plurality of logical channels (318), and where the link transmitter selects from which of the plurality of channels to draw the packet. The link receiver transmits a flow control packet (332) to the link transmitter to add additional data credits (334) to the plurality of data credits, where the link transmitter selects to which of the plurality of logical channels to allocate the additional data credits. A plurality of receiver buffers (322) are placed into a free buffer pool (330) as the packet is transmitting out of the plurality of receiver buffers, where the free buffer pool corresponds to additional data credits. The link receiver transmitting the flow control packet to the link transmitter on the reverse link (314) if the free buffer pool contains additional data credits and the reverse link is idle.

### RELATED CASE

Related subject matter is disclosed in U.S. patent application entitled “METHOD OF TRANSMITTER ORIENTED LINK FLOW CONTROL” having application Ser. No. ______ and filed on the same date herewith and assigned to the same assignee.

Related subject matter is disclosed in U.S. patent application entitled “METHOD OF EARLY BUFFER RETURN” having application Ser. No. ______ and filed on the same date herewith and assigned to the same assignee.

### BACKGROUND OF THE INVENTION

As a link flow control scheme regulates the flow of traffic in a network, it can also limit the utilization of the links to less than 100%. This can happen if nodes are not provisioned with enough packet buffering memory or if the nodes are not generating link flow control updates often enough or soon enough.

Link flow control protocols implemented in today's commercial integrated circuits perform sub-optimally in real-world networks. This can result in network links operating at less than full efficiency. Enhancing link flow control mechanisms is an effective way to make better use of limited packet buffering memory so that high link utilizations can be achieved with significantly less packet buffering memory. Since packet buffering memory is a major consumer of real estate in switch integrated circuits, reducing the amount of packet buffering memory will result in smaller switch integrated circuit die sizes, and consequently lower prices.

Accordingly, there is a significant need for an apparatus and method that overcomes the deficiencies of the prior art outlined above.

### BRIEF DESCRIPTION OF THE DRAWINGS

Referring to the drawing:

FIG. 1 depicts a switch fabric network according to one embodiment of the invention;

FIG. 2 depicts a distributed switch fabric according to an embodiment of the invention;

FIG. 3 depicts a network according to an embodiment of the invention;

FIG. 4 illustrates a flow diagram of a method of the invention according to an embodiment of the invention;

FIG. 5 illustrates a flow diagram of a method of the invention according to another embodiment of the invention; and

FIG. 6 illustrates a flow diagram of a method of the invention according to yet another embodiment of the invention.

It will be appreciated that for simplicity and clarity of illustration, elements shown in the drawing have not necessarily been drawn to scale. For example, the dimensions of some of the elements are exaggerated relative to each other. Further, where considered appropriate, reference numerals have been repeated among the Figures to indicate corresponding elements.

### DESCRIPTION OF THE PREFERRED EMBODIMENT

In the following detailed description of exemplary embodiments of the invention, reference is made to the accompanying drawings, which illustrate specific exemplary embodiments in which the invention may be practiced. These embodiments are described in sufficient detail to enable those skilled in the art to practice the invention, but other embodiments may be utilized and logical, mechanical, electrical and other changes may be made without departing from the scope of the present invention. The following detailed description is, therefore, not to be taken in a limiting sense, and the scope of the present invention is defined only by the appended claims.

In the following description, numerous specific details are set forth to provide a thorough understanding of the invention. However, it is understood that the invention may be practiced without these specific details. In other instances, well-known circuits, structures and techniques have not been shown in detail in order not to obscure the invention.

In the following description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact. However, “coupled” may mean that two or more elements are not in direct contact with each other, but yet still co-operate or interact with each other.

For clarity of explanation, the embodiments of the present invention are presented, in part, as comprising individual functional blocks. The functions represented by these blocks may be provided through the use of either shared or dedicated hardware (processors, memory, and the like), including, but not limited to, hardware capable of executing software. The present invention is not limited to implementation by any particular set of elements, and the description herein is merely representational of one embodiment.

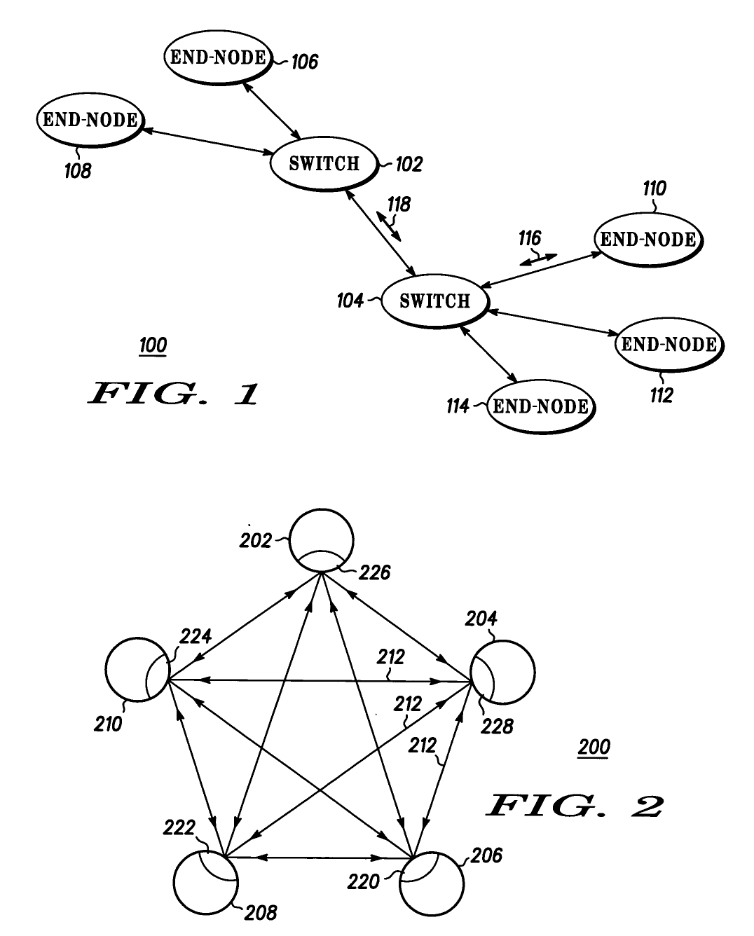

FIG. 1 depicts a switch fabric network 100 according to one embodiment of the invention. As shown in FIG. 1, switch fabric network 100 can have any number of end-nodes 106-114 connected to each other through a switch fabric, where the switch fabric can comprise one or more switches 102, 104 and/or routers. Each connection between switches 102, 104 and end-nodes 106-114 is a point-to-point serial connection. Data exchanged in switch fabric network 100 can be in the form of packets 116, 118. As is known in the art, packets 116, 118 generally comprise a header portion that instructs the switch 102, 104 as to the destination node of the packet 116, 118.

Switch 102, 104 is usually manifested as a switch card in a chassis. Switch 102, 104 provides the data/packet distribution for the system. Each end-node 106-114 can be a node such as a processor, database, and the like, or each node can be another sub-network. In switch fabric network 100 there can be any number of hierarchies of switches and end-nodes.

Switch fabric network 100 can utilize, for example and without limitation, Common Switch Interface Specification (CSIX) for communication between switches and end-nodes. CSIX defines electrical and packet control protocol layers for traffic management and communication. Packet traffic can be serialized over links suitable for a backplane-based interconnect environment. The CSIX packet protocol encapsulates any higher-level protocols allowing interoperability in an open architecture environment.

As described above, switch fabric network 100 can be based on a point-to-point, switched input/output (I/O) fabric, whereby switch devices interconnect end node devices. Switch fabric network 100 can include both module-to-module (for example computer systems that support I/O module add-in slots) and chassis-to-chassis environments (for example interconnecting computers, external storage systems, external Local Area Network (LAN) and Wide Area Network (WAN) access devices in a data-center environment). Switch fabric network 100 can be implemented by using one or more of a plurality of switched fabric network standards, for example and without limitation, InfiniBand™, Serial RapidIO™, and the like. Switch fabric network 100 is not limited to the use of these switched fabric network standards and the use of any switched fabric network standard is within the scope of the invention.

FIG. 2 depicts a distributed switch fabric network 200 according to an embodiment of the invention. As shown in FIG. 2, distributed switch fabric network 200 is an embodiment of, or a subset of switch fabric network 100 where each node has a point-to-point connection such that all nodes 202-210 have connections to all other nodes 202-210. In this configuration, distributed switch fabric network 200 creates a fully populated, non-blocking switch fabric. Distributed switch fabric network 200 has a plurality of nodes 202-210 coupled to mesh network 212, in which each node 202-210 has a direct route to all other nodes and does not have to route traffic for other nodes.

In distributed switch fabric network 200 each node switches its own traffic (i.e. packets), and therefore has a portion of switching function 220-228. There is no dependence on an independent switch, as all nodes 202-210 are equal in a peer-to-peer system. In other words, each of nodes 202-210 includes at least a portion of switching function 220-228.

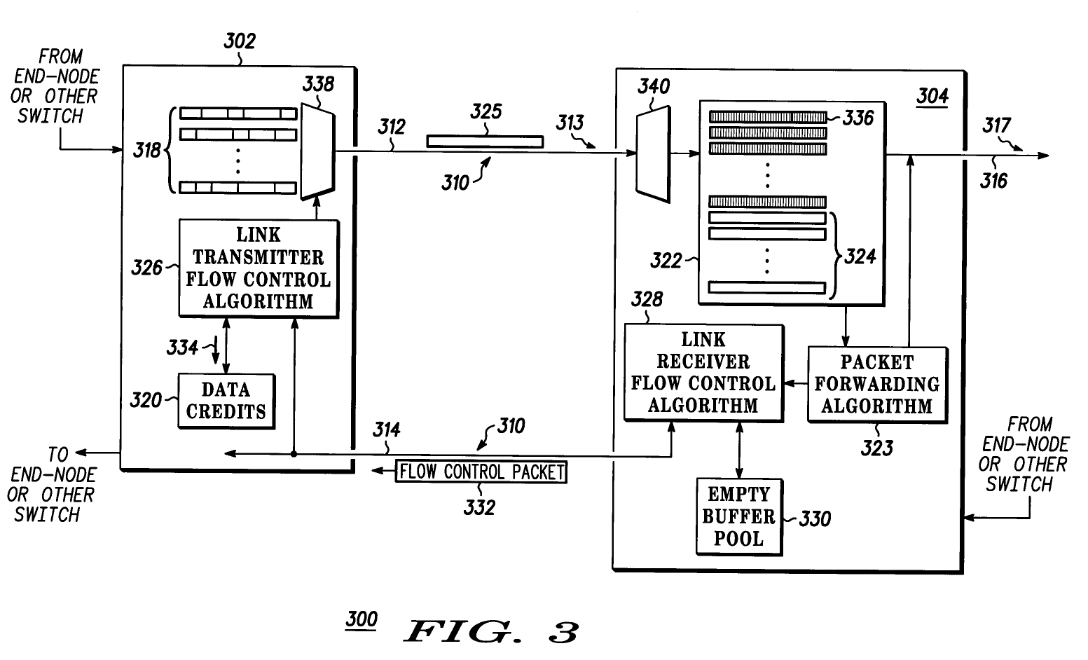

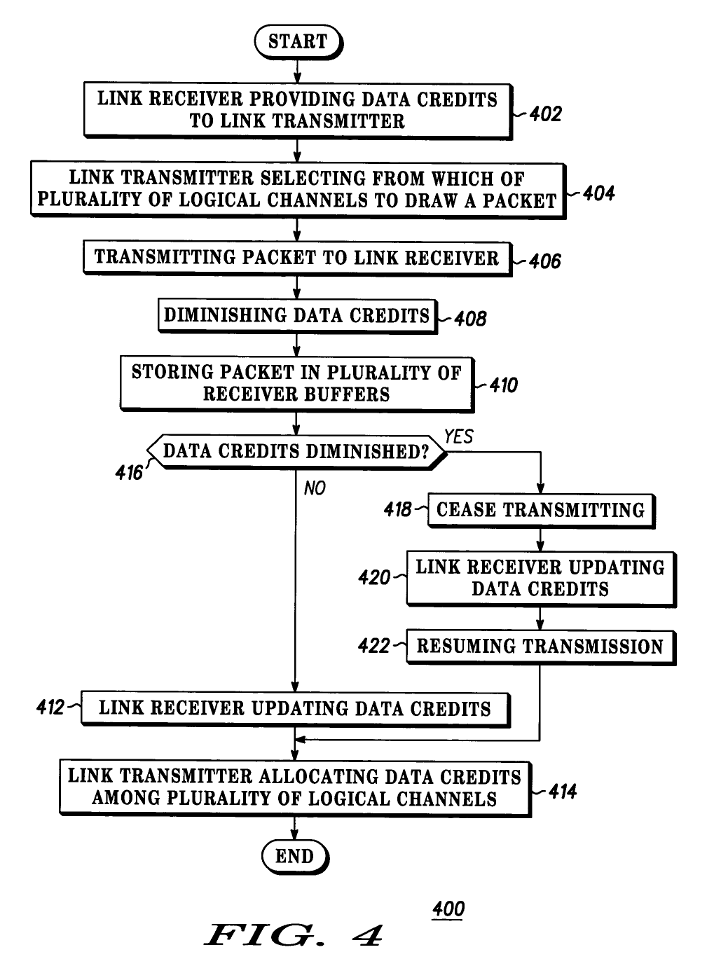

FIG. 3 depicts a network 300 according to an embodiment of the invention. In the embodiment depicted in FIG. 3, each of switches 102, 104 depicted in FIG. 1 and/or the switching functions 220-228 depicted in FIG. 2 can be represented as link transmitter 302 and link receiver 304. Link transmitter 302 and link receiver 304 are coupled by ingress link 310, which can be a bi-directional link having a forward link 312 and a reverse link 314. A packet 325 is transmitted from link transmitter 302 to link receiver 304 over the forward link 312, while a flow control packet 332 is transmitted from link receiver 304 to link transmitter 302 over reverse link 314.

The network 300 shown in the embodiment operates using a credit-based link flow control scheme. In an embodiment, link flow control operates over one bi-directional link, for example ingress link 310. Link transmitter 302 drives ingress link at the “upstream” end with packet 325 going in the “forward” or “downstream” direction on forward link 312. Link receiver 304 sits at the “downstream” end and receives packet 325 that has crossed ingress link 310 from link transmitter 302. The ingress link 310 path in the opposite direction is along reverse link 314, and traffic going in this direction is “upstream” traffic. In an embodiment, link receiver 304 generates and sends flow control packet 332 upstream to link transmitter 302 on reverse link 314. After receiving flow control packet 332, link transmitter 302 can update link flow control variables.

Since ingress link 310 is bidirectional, the above sequence of events can occur simultaneously for the opposite orientation of the “upstream” and “downstream” directions. In other words, link transmitter 302 can operate as a link receiver, and link receiver 304 can operate as link transmitter with the role of the forward link 312 and reverse link 314 swapped. Therefore, packets 325 can travel reverse link 314 from link receiver 304 to link transmitter 302 and flow control packet 332 can travel forward link 312 from link transmitter 302 to link receiver. To avoid confusion, the following embodiments will be described with reference to packets 325 communicated over forward link 312 and flow control packets 332 communicated over reverse link 314 with the understanding that the same process can occur simultaneously with link transmitter 302 and link receiver 304 transposing roles in the link flow control operation.

Link transmitter.302 can comprise transmit multiplexer 338 coupled to a plurality of logical channels 318. In an embodiment, plurality of logical channels 318 can be random access memory (RAM), flash memory, electrically erasable programmable ROM (EEPROM), and the like. Each of plurality of logical channels 318 can store one or more packets awaiting transmission to link receiver 304. Packets entering plurality of logical channels 318 can come from end-nodes or other switches via other links coupled to link transmitter 302. Each of plurality of logical channels 318 can operate independently storing different priority levels of packets. For example, plurality of logical channels 318 can be used in a quality of service (QoS) or class of service (CoS) algorithm to prioritize packet traffic from link transmitter 302 to link receiver 304. For example, and not meant to be limiting of the invention, plurality of logical channels can be virtual lanes (VL) in a network operating under the Infiniband network standard.

Link receiver 304 can have a receiver multiplexer 340 coupled to a plurality of receiver buffers 322 to store each packet 325 transmitted by link transmitter 302. Plurality of receiver buffers 322 can be random access memory (RAM), flash memory, electrically erasable programmable ROM (EEPROM), and the like. In an example of an embodiment, each of plurality of receiver buffers 322 can be 64 bytes.

In the credit-based link flow control scheme, link receiver 304 provides plurality of data credits 320 to link transmitter 302. Each of plurality of data credits 320 can represent one of plurality of receiver buffers 322 that is empty and ready to receive packet data. In general, one of the plurality of data credits 320 is a count and does not correspond to a particular one of plurality of receiver buffers 322. As an example of an embodiment, link receiver 304 can provide plurality of data credits 320 at initialization of network 300, where network can be a switch fabric network, or as a more specific example, network 300 can be a distributed switch fabric network.

As each packets 325 is drawn from plurality of logical channels 318 and transmitted from link transmitter 302 to link receiver 304, link transmitter flow control algorithm 326 ensures plurality of data credits 320 is diminished. This is because each packet 325 transmitted to link receiver 304 is stored in plurality of receiver buffers 322, thereby diminishing an empty portion of plurality of receiver buffers 324 available to store packets 325. Link transmitter flow control algorithm 326 allows link transmitter 302 to continue to transmit packets 325 to link receiver 304 as long as there are plurality of data credits 320 available. If plurality of data credits 320 is diminished or reaches a threshold level, link transmitter ceases transmitting packets 325 to link receiver 304. This prevents link receiver 304 from becoming over-subscribed and is an example of link flow control, since the over-subscription is prevented and/or controlled at the link level (i.e. over ingress link 310 connecting link transmitter 302 and link receiver 304).

Link transmitter takes a packet 325 from one of the plurality of logical channels 318 for transmission to link receiver 304. In an embodiment, link transmitter 302 selects from which of the plurality of logical channels 318 to draw the packet 325. In other words, it is link transmitter 302 that decides how to allocate plurality of data credits 320 among the plurality of logical channels 318 to decide from which of plurality of logical channels 318 to draw a packet 325 for transmission to link receiver 304. Since link transmitter 302 knows how much traffic (i.e. how many packets 325) are queued up on each of plurality of logical channels 318, link transmitter 302 is in the best position to know how best to allocate plurality of data credits 320. This has the advantage of allocating plurality of data credits 320 more efficiently among plurality of logical channels 318 as opposed to the prior art method of allowing link receiver 304 to allocate plurality of data credits 320 among plurality of logical channels 318.

In the prior art, link receiver 304 had no knowledge of the volume of traffic queued in each of plurality of logical channels 318, but would allocate plurality of data credits 320 to plurality of logical channels 318 based on a rigid QoS or CoS algorithm. This prior art methodology has the disadvantage in that plurality of data credits 320 can be allocated to one or more of plurality of logical channels 318 that have no traffic queued. In this situation, plurality of data credits 320 cannot be used until traffic arrived, which was an inefficient use of bandwidth in ingress link 310. The present invention has the advantage of allowing link transmitter 302 to allocate plurality of data credits 320 based on link transmitter's knowledge of traffic queued on plurality of logical channels 318 and any QoS or CoS algorithm.

After storage in plurality of receiver buffers 322, packet 325 or a portion of packet 336, is transmitted out of link receiver via egress link 316 according to packet forwarding algorithm 323. When this occurs, the portion of plurality of receiver buffers 322 occupied by packet 325 or a portion of packet 336, is emptied and returned to free buffer pool 330 via link receiver flow control algorithm 328. The free buffer pool 330 represents an empty portion of plurality of receiver buffers 324. The empty portion of plurality of receiver buffers 324 are ready to receive new data in the form of a packet 325 or portion of a packet 336. However, at this stage, link transmitter 302 is unaware of the empty portion of plurality of receiver buffers 324.

At intervals to be discussed further below, link receiver 304 transmits flow control packet 332 to link transmitter 302. Flow control packet 332 can comprise additional data credits 334. Each additional data credits 334 can represent one of plurality of receiver buffers 322 that is empty and ready to receive packet data. In effect, link receiver 304 is updating plurality of data credits 320 at link transmitter 302 by transmitting link flow control packet 332. In other words, link receiver 304 is notifying link transmitter 302 of an empty portion of plurality of receiver buffers 324, thereby replenishing plurality of data credits 320 by adding additional data credits 334. In an embodiment, link transmitter 302 selects to which of plurality of logical channels 318 to allocate additional data credits 334.

As described above, link transmitter flow control algorithm 326 allows link transmitter 302 to continue to transmit packets 325 to link receiver 304 as long as there are plurality of data credits 320 available at link transmitter 302. If plurality of data credits 320 is completely diminished or reaches a threshold level before the arrival of additional data credits 334, link transmitter ceases transmitting packets 325 to link receiver 304. In an embodiment, if link transmitter 302 has ceased transmitting packets 325 to link receiver 304, link transmitter 302 can resume transmission upon receiving additional data credits 334. In effect, when plurality of data credits 320 is replenished by additional data credits 334, link transmitter 302 can resume transmission of packets 325 to link receiver 304.

As discussed above, after storage in plurality of receiver buffers 322, packet 325 or a portion of packet 336, is transmitted out of link receiver via egress link 316 according to packet forwarding algorithm 323. When this occurs, the portion of plurality of receiver buffers 322 occupied by packet 325, or a portion of packet 336, is emptied and returned to free buffer pool 330 via link receiver flow control algorithm 328. Free buffer pool 330 represents an empty portion of plurality of receiver buffers 324. In general, a packet 325 occupies more than one of plurality of receiver buffers 322.

In an embodiment; plurality of receiver buffers 322 occupied by packet 325 are placed into free buffer pool 330 by link receiver flow control algorithm 328 as packet 325 is transmitting out of plurality of receiver buffers 322 (i.e. early buffer return). The placing of plurality of receiver buffers 322 means that a count is taken of plurality of receiver buffers 322. In other words, as packet 325 is being transmitted out plurality of receiver buffers 322, all of plurality of receiver buffers 322 occupied by packet 325 are placed in free buffer pool 330. This has the effect of giving link transmitter 302 “advanced notice” of the empty portion of plurality of receiver buffers 322. This has the advantage of placing the plurality of receiver buffers 322 occupied by packet 325 back into free buffer pool 330 as soon as possible so that link transmitter 302 can obtain the corresponding additional data credits 334 as soon as possible and begin transmitting more packets 325, thereby making the most efficient use of the bandwidth of ingress link 310, particularly forward link 312. This also reduces the round trip time between link transmitter 302 transmitting packet 325 and link receiver 304 transmitting flow control packet 332, thereby reducing the amount of plurality of receiver buffers 322 required to achieve and maintain full ingress link utilization.

Ingress link 310, particularly forward link 312, has an ingress link speed 313. Also, egress link 316 has an egress link speed 317. In one embodiment where egress link speed 317 is equal to or greater than ingress link speed 313, plurality of receiver buffers 322 occupied by packet 325 can be placed into free buffer pool 330 when packet 325 begins transmitting out of plurality of receiver buffers 322. In a particular embodiment, packet 325 begins transmitting when one of the plurality of receiver buffers 322 occupied by packet is empty. In another particular embodiment, plurality of receiver buffers 322 occupied by packet 325 can be placed into free buffer pool 330 when the first one of the plurality of receiver buffers 322 occupied by packet begins emptying.

In another embodiment wherein egress link speed 317 is less than ingress link speed 313, plurality of receiver buffers 322 occupied by packet 325 can be placed into free buffer pool 330 after a portion of packet 336 has been transmitted out of plurality of receiver buffers 322. This is because when egress link speed 317 is slower than ingress link speed 313, plurality of receiver buffers 322 can be filled faster than they can be emptied, thereby over-running the buffering capacity of link receiver 304. In a particular embodiment, portion of packet 336 is proportional to a ratio of egress link speed 317 to ingress link speed 313. As an example of an embodiment that is not limiting of the invention, portion of packet 336 is substantially equal to one minus the ratio of egress link speed 317 to ingress link speed 313.

As described above, ingress link is bi-directional with packets 325 and flow control packets 332 operating in both directions on forward link 312 and reverse link 314 of ingress link 310. At anytime, one or both of forward link 312 or reverse link 314 can be idle, where there is no traffic on the respective link in either direction.

Once free buffer pool 330 has additional data credits 334 allocated to it as explained above, link receiver 304 then forwards flow control packet 332 to link transmitter 302 so that the additional data credits 334 can be used to update plurality of data credits. In one embodiment, if free buffer pool 330 has additional data credits 334 allocated and reverse link 314 is idle, flow control packet 332 can be automatically sent to link transmitter 302. As an example of an embodiment, if link receiver flow control algorithm 328 detects that free buffer pool 330 contains additional data credits 334 and that reverse link 314 is idle, then link receiver flow control algorithm 328 transmits flow control packet 332 to link transmitter 302. This embodiment has the advantage, when coupled with scheduled transmissions of flow control packet 332, of increasing the odds that link transmitter 302 has a full supply of plurality of data credits 320 so that link transmitter 302 can sustain the longest possible traffic burst of packets 325 before needing additional data credits 334. This maximizes the ability of link transmitter 302 to handle traffic restraints for a given number of plurality of data credits 320 (i.e. empty portion of plurality of receiver buffers 324 allocated to a given one of plurality of logical channels 318).

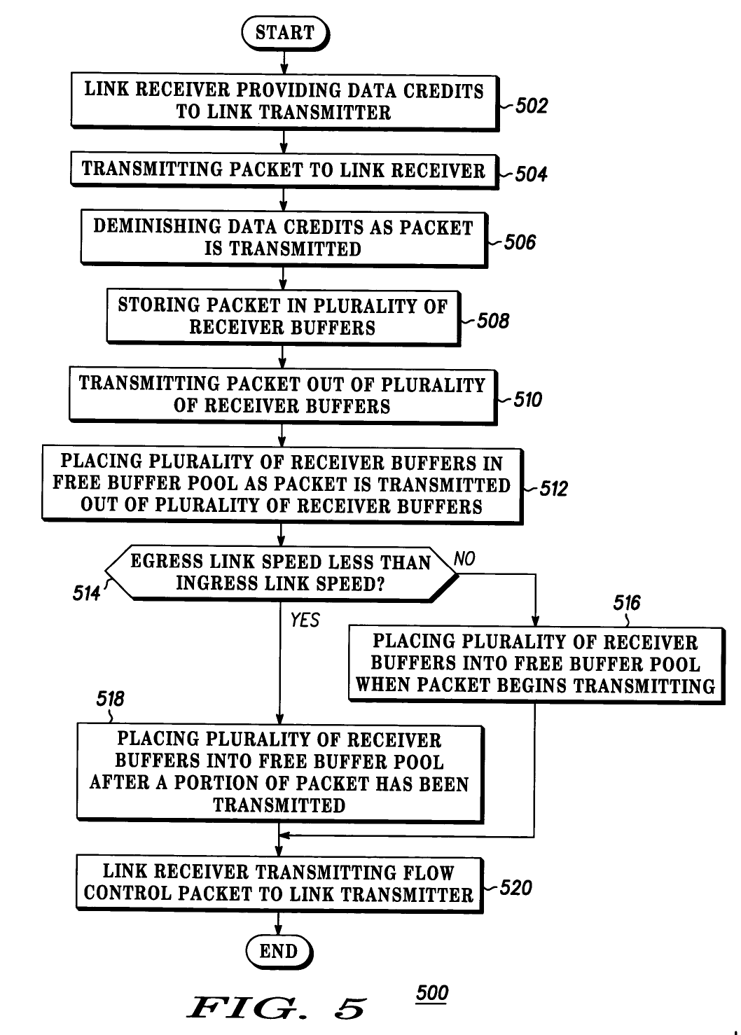

FIG. 4 illustrates a flow diagram 400 of a method of the invention according to an embodiment of the invention. In step 402, link receiver 304 provides a plurality of data credits 320 to link transmitter 302 in a credit-based flow control scheme. In step 404, link transmitter 302 selects from which of a plurality of logical channels to draw a packet 325. In step 406, link transmitter 302 transmits packet 325 to link receiver 304. Plurality of data credits 320 are diminished as packet 325 is transmitted in step 408. Packet 325 is stored in plurality of receiver buffers 322 in step 410.

In step 416 it is determined if plurality of data credits 320 at link transmitter 302 are diminished or at a threshold value. If so, link transmitter 302 ceases transmitting packets 325 to link receiver 304 per step 418. In step 420, link receiver 304 updates plurality of data credits 320 by sending additional data credits 334 via flow control packet 332. Transmission of packets 325 resumes from link transmitter 302 to link receiver 304 per step 422.

If plurality of data credits 320 are not diminished or have not reached a threshold value per step 416, link transmitter continues to transmit packets 325 to link receiver 304 and link receiver 304 updates plurality of data credits 320 per step 412. In step 414, link transmitter allocates plurality of data credits 320 among plurality of logical channels 318.

FIG. 5 illustrates a flow diagram 500 of a method of the invention according to another embodiment of the invention. In step 502, link receiver 304 provides a plurality of data credits 320 to link transmitter 302 in a credit-based flow control scheme. In step 504, link transmitter 302 transmits packet 325 to link receiver 304. Plurality of data credits 320 are diminished as packet 325 is transmitted in step 506. Packet 325 is stored in plurality of receiver buffers 322 in step 508. In step 510, link receiver 304 transmits packet 325 out of plurality of receiver buffers 322 on egress link 316. In step 512, plurality of receiver buffers 322 are placed in free buffer pool 330 as packet 325 is transmitted out of plurality of receiver buffers 322.

In step 514, it is determined if egress link speed 317 is less than ingress link speed 313. If so, plurality of receiver buffers 322 are placed in free buffer pool 330 after a portion of packet 325 has been transmitted out of plurality receiver buffers 322 per step 518. Thereafter, link receiver 304 transmits flow control packet 332 to link transmitter 302 per step 520.

If egress link speed 317 is not less than ingress link speed 313, then plurality of receiver buffers are placed into free buffer pool 330 when packet 325 begins transmitting out of plurality of receiver buffers 322 per step 516. In one embodiment, packet 325 begins transmitting when one of the plurality of receiver buffers 322 occupied by packet 325 is empty. Thereafter, link receiver 304 transmits flow control packet 332 to link transmitter 302 per step 520.

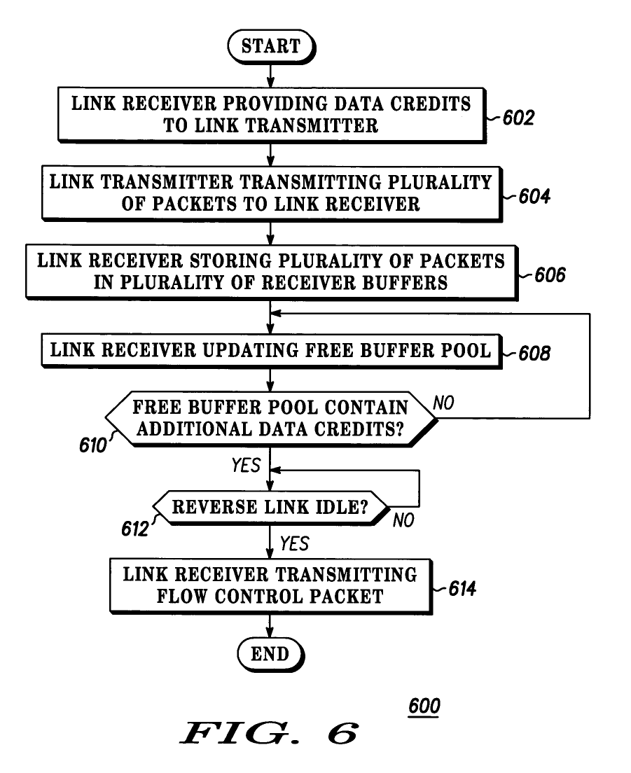

FIG. 6 illustrates a flow diagram 600 of a method of the invention according to yet another embodiment of the invention. In step 602, link receiver 304 provides a plurality of data credits 320 to link transmitter 302 in a credit-based flow control scheme. In step 604, link transmitter 302 transmits packet 325 to link receiver 304. Packet 325 is stored in plurality of receiver buffers 322 in step 606. In step 608, link receiver 304 updates free buffer pool 330.

In step 610 it is determined if the free buffer pool 330 contains additional data credits 334. If not, link receiver flow control algorithm 328 awaits an update of the free buffer pool 330 per step 608. If free buffer pool 330 does contain additional data credits 334 per step 610, then it is determined if reverse link 314 is idle per step 612. When reverse link 314 is idle per step 612, link receiver 304 transmits flow control packet per step 614.

While we have shown and described specific embodiments of the present invention, further modifications and improvements will occur to those skilled in the art. It is therefore, to be understood that appended claims are intended to cover all such modifications and changes as fall within the true spirit and scope of the invention.

1. A method, comprising:
a link receiver providing a plurality of data credits to a link transmitter;
the link transmitter transmitting a plurality of packets to the link receiver on an ingress link, wherein the ingress link has a forward link and a reverse link, and wherein the plurality of packets are transmitted on the forward link;
the link receiver storing the plurality of packets in a plurality of receiver buffers;
the link receiver updating a free buffer pool; and
the link receiver transmitting a flow control packet to the link transmitter on the reverse link if the free buffer pool contains additional data credits and the reverse link is idle, wherein the flow control packet comprises the additional data credits.

2. The method of claim 1, wherein the link receiver updating the free buffer pool comprises the link receiver updating the free buffer pool as one of the plurality of packets is transmitted out of the plurality of receiver buffers.

3. The method of claim 1, wherein the flow control packet notifies the link transmitter of an empty portion of the plurality of receiver buffers.

4. The method of claim 1, wherein one of the plurality of data credits corresponds to one of the plurality of receiver buffers being empty.

5. The method of claim 1, further comprising wherein the link transmitter has a plurality of logical channels, and wherein the link transmitter selects to which of the plurality of logical channels to allocate the additional data credits.

6. The method of claim 1, further comprising wherein the link transmitter has a plurality of logical channels, and wherein the link receiver selects to which of the plurality of logical channels to allocate the additional data credits.

7. The method of claim 1, wherein the link transmitter and the link receiver operate in a switch fabric network.

8. The method of claim 7, wherein the switch fabric network is one of an Infiniband network and a Serial RapidIO network.

9. A switch, comprising:
a plurality of receiver buffers coupled to receive a packet from a link transmitter on an ingress link having a forward link and a reverse link, wherein the packet is stored in the plurality of receiver buffers;
a free buffer pool; and
a link receiver flow control algorithm, wherein the link receiver flow control algorithm transmits a flow control packet to the link transmitter on the reverse link if the free buffer pool contains additional data credits and the reverse link is idle, wherein the flow control packet comprises the additional data credits.

10. The switch of claim 9, wherein the flow control packet notifies the link transmitter of an empty portion of the plurality of receiver buffers.

11. The switch of claim 9, wherein one of the plurality of data credits corresponds to one of the plurality of receiver buffers being empty.

12. The switch of claim 9, further comprising wherein the link transmitter has a plurality of logical channels, and wherein the link transmitter selects to which of the plurality of logical channels to allocate the additional data credits.

13. The switch of claim 9, further comprising a link receiver, wherein the link transmitter has a plurality of logical channels, and wherein the link receiver selects to which of the plurality of logical channels to allocate the additional data credits.

14. The switch of claim 9, further comprising a link receiver, wherein the link transmitter and the link receiver operate in a switch fabric network.

15. The switch of claim 14, wherein the switch fabric network is one of an Infiniband network and a Serial RapidIO network.

16. A computer-readable medium containing computer instructions for instructing a processor to perform a method of updating a link transmitter, the instructions comprising:
a link receiver providing a plurality of data credits to the link transmitter;
the link transmitter transmitting a plurality of packets to the link receiver on an ingress link, wherein the ingress link has a forward link and reverse link, and wherein the plurality of packets are transmitted on the forward link;
the link receiver storing the plurality of packets in a plurality of receiver buffers;
the link receiver updating a free buffer pool; and
the link receiver transmitting a flow control packet to the link transmitter on the reverse link if the free buffer pool contains additional data credits and the reverse link is idle, wherein the flow control packet comprises the additional data credits.

17. The computer-readable medium of claim 16, wherein the link receiver updating the free buffer pool comprises the link receiver updating the free buffer pool as one of the plurality of packets is transmitted out of the plurality of receiver buffers.

18. The computer-readable medium of claim 16, wherein the flow control packet notifies the link transmitter of an empty portion of the plurality of receiver buffers.

19. The computer-readable medium of claim 16, wherein one of the plurality of data credits corresponds to one of the plurality of receiver buffers being empty.

20. The computer-readable medium of claim 16, further comprising wherein the link transmitter has a plurality of logical channels, and wherein the link transmitter selects to which of the plurality of logical channels to allocate the additional data credits.

21. The computer-readable medium of claim 16, further comprising wherein the link transmitter has a plurality of logical channels, and wherein the link receiver selects to which of the plurality of logical channels to allocate the additional data credits.

22. The computer-readable medium of claim 16, wherein the link transmitter and the link receiver operate in a switch fabric network.

23. The computer-readable medium of claim 20, wherein the switch fabric network is one of an Infiniband network and a Serial RapidIO network.
